(19) United States
(12) Patent Application Publication
(10) Pub. No.: US 2012/0130101 A1
(43) Pub. Date: May 24, 2012

(54) CERAMIC CATALYST USED IN MANUFACTURE OF FATTY ACID ALKYL ESTERS AND METHOD FOR PREPARING HIGH PURITY FATTY ACID ALKYL ESTERS USING THE SAME

(75) Inventors: Jeong Woo Yoo, Uiwang-si (KR); Hae Reun Jang, Sungnam-si (KR); Hee Jun Hyoung, Yeoju-gun (KR)

(73) Assignee: S.M.POT Co., Ltd, Yeoju-gun (KR)

(21) Appl. No.: 13/130,250

(22) PCT Filed: Nov. 2, 2009
(86) PCT No.: PCT/KR2009/006382

§ 371 Date: Aug. 8, 2011

(30) Foreign Application Priority Data
Nov. 19, 2008 (KR) 10-2008-0115147

(51) Int. Cl. C11C 3/04; B01J 37/08; B01J 21/16

(52) U.S. Cl. 554/167; 502/80; 502/84

(57) ABSTRACT

The present invention relates to a catalyst used in the manufacture of fatty acid alkyl esters and a method for preparing fatty acid alkyl esters using the same. The invention provides a high hardness solid ceramic metal catalyst obtained by mixing and sintering 0 wt %-80 wt % active catalyst material with a support material, wherein the support material is a silica alumina that is a mixed metal oxide and the active catalyst material is at least one of oxides, carbonates, and hydroxides of any kind selected from magnesium (Mg), calcium (Ca), zinc (Zn), titanium (Ti), manganese (Mn), vanadium (V), beryllium (Be), copper r (Cu), zirconium (Zr), strontium (Sr), tin (Sn), and barium (Ba). In addition, the invention provides a method for preparing fatty acid alkyl esters by performing transesterification and esterification of animal and vegetable oils and alcohols in the state where the ceramic metal catalyst is fixed within a reactor without processes for removing and purifying the catalyst.

### FIELD OF THE INVENTION

The present invention relates to a catalyst used to produce fatty acid alkyl ester and a method of producing high-purity fatty acid alkyl ester by using the same. In particular, the present invention relates to a ceramic catalyst that eliminates the necessity of a catalyst removal or purification process in case fatty acid alkyl ester is produced, and a production method using the same.

### BACKGROUND OF THE INVENTION

Most of the processes for producing fatty acid alkyl ester and glycerin, which are being commercially used all over the world, use strong alkali homogeneous catalysts. European Patent Publication No. 0,301,634 discloses a process of producing ester by using a strong alkali catalyst such as sodium hydroxide (NaOH), potassium hydroxide (KOH), sodium carbonate (Na₂CO₃), potassium carbonate (K₂CO₃), sodium bicarbonate (NaHCO₃) and potassium bicarbonate (KHCO₃), and the Journal of the American Oil Chemists' Society (JAOCS) discloses on its vol. 63, page 1,375 a process of producing fatty acid alkyl ester and glycerin by using sodium methoxide (NaOMe), sodium butoxide (NaOBu), etc. Further, U.S. Pat. No. 4,608,202 discloses synthesizing fatty acid alkyl ester by using sodium methoxide (NaOMe), and the Journal of the American Oil Chemists' Society (JAOCS) discloses on its vol. 61, page 1,638 a method of synthesizing fatty acid alkyl ester by using sodium hydroxide (NaOH) and sodium methoxide (NaOMe). Furthermore, U.S. Pat. No. 4,363,590 discloses synthesizing fatty acid alkyl ester by using sodium (Na), which is alkali metal. Besides the above, U.S. Pat. No. 4,363,590, International Patent Publication No. WO91/05034, and the Journal of the American Oil Chemists' Society (JAOCS) vol. 61, page 343, vol. 61, page 1,638 and vol. 63, page 1,375 are the patents and the materials relating to methods of producing fatty acid alkyl ester by using a catalyst such as potassium methoxide (KOMe) and strong alkali homogeneous catalysts as mentioned above.

In case of producing fatty acid alkyl ester and glycerin by using these strong alkali homogeneous catalysts, the reaction speed is very fast, and thus, the reaction can be achieved under a relatively mild condition of 50° C.˜80° C. and atmospheric pressure. However, in the above-mentioned reaction, soap and catalysts are produced together with the fatty acid alkyl ester and the glycerin due to the use of a homogeneous catalyst. Therefore, the fatty acid alkyl ester having the soap and the catalysts needs to be cleansed with sulfuric acid water and RO (Reverse Osmosis) water, dried, and distilled to obtain purified fatty acid alkyl ester at last. Further, for the glycerin having the soap and the catalysts, the soap component needs to be separated into fatty acid and water with water-diluted sulfuric acid, the remaining of the catalysts be neutralized to produce salt, and the produced salt be removed, and then, purified glycerin is obtained after a drying and distillation process.

As such, in case of producing fatty acid alkyl ester or glycerin by using a strong alkali homogeneous catalyst, soap and catalysts are dissolved in the product, and thus, lots of very complicated processes are additionally required so as to remove the soap and the catalysts. Therefore, problems arise as follows: the production cost increases high; the process goes complicated; and the waste water and waste oil produced during the soap and catalyst removal process may cause environmental pollution.

Therefore, researches are recently being performed in an active manner with regard to a production process using a heterogeneous catalyst, so as to avoid the problems as mentioned above in relation to the process of producing fatty acid alkyl ester by using a homogeneous catalyst.

Korean Patent Laid-open Publication No. 2002-28120 and the Journal of Life Science (2004), vol. 14, No. 2, pages 269 to 274 disclose that heterogeneous catalysts such as ZnO, MgO, CaO, MnO, TiO₂ are widely used to produce fatty acid alkyl ester. However, a production reaction for fatty acid alkyl ester by the above-mentioned catalysts occur at a high temperature of 150° C.˜250° C., differently from one by an alkali homogeneous catalyst, and thus, the above-mentioned catalysts still cause the same problems as an alkali homogeneous catalyst because the metal oxide is subject to saponification.

Meanwhile, European Patent Publication No. 0,198,243 discloses producing fatty acid methyl ester in a fixed bed reactor with a mixture of alumina (Al₂O₂) or alumina and ferrous oxide (FeO), and British Patent No. 795,573 presents a method of producing fatty acid methyl ester by reacting zinc silicate with methanol under a condition of 250° C.˜280° C. and no higher than 100 bar. However, a process of refining fatty acid alkyl ester and glycerin was problematically required because using a zinc compound as a catalyst at a high temperature led to production of zinc soap. A similar method is disclosed in European Patent Publication No. 0,193,243 and British Patent No. 795,573. Meanwhile, U.S. Pat. No. 4,668,439 discloses a method of using metal soap such as zinc laurate as a catalyst under a condition of 210° C.˜280° C. and atmospheric pressure, and International Patent Publication No. WO2007/012097 discloses a method of synthesizing fatty acid alkyl ester by using a liquefied metal catalyst, which is alkali earth metal salt from carboxylic acid, like metal soap such as stearate magnesium, instead of zinc soap.

Meanwhile, European Patent Laid-open Publication No. 1,468,734 discloses a method for obtaining a ZnAl₂O₄, xZnO, yAl₂O₃ catalyst. Looking into the details, a spinel-structured catalyst is produced by physically mixing alumina gel (Al₂O₃) including water by 25% with water and nitric acid, which is strong acid, and then mixing it on an adequate proportion with zinc oxide (ZnO), zinc carbonate (ZnCO₃) and nitric acid compounds such as zinc nitrate (ZnNO₃) and sintering it at a high temperature of no higher than 1,000° C. Considering that the spinel structure is destroyed when the firing and sintering is performed at a high temperature of no lower than 1,000° C., it can be assumed that there are constraints concerning the reaction temperature. Meanwhile, since the catalyst is produced with strong acid, the production becomes very risky and a great amount of nitrogen oxide (NOₓ) generated during the sintering causes corrosion and pollution to the equipments, which are problematic.

U.S. Pat. No. 5,908,946 discloses a method of producing fatty acid alkyl ester by using a heterogeneous catalyst, which is similar to the afore-mentioned catalyst in its structure but produced in a different way. This publication discloses a process of producing fatty acid alkyl ester and high-purity glycerin based on a discontinuous process using a catalyst having the structure of a spinel, ZnAl₂O₄, xZnO, yAl₂O₃ (x, y=0˜2), or a continuous process using a fixed bed reactor or a plurality of autoclaves. According to the publication, a method is disclosed producing fatty acid alkyl ester of 97% or higher purity at maximum and glycerin of 99.5% or higher purity by reacting vegetable and animal oil having 6 to 26 carbon atoms with mono-alcohol having 1 to 5 carbon atoms through using a spinel-structured ZnAl₂O₄, xZnO, yAl₂O₃ catalyst including zinc oxide (ZnO) of powder type, pellet type and ball type under a condition of 170° C.˜250° C. and no higher than 100 bar, and then distilling and purifying the fatty acid alkyl ester to produce fatty acid alkyl ester of 99.8% or higher purity. Herein, the methods of producing the catalysts, which are main subject matters, are as follows:

(1) a method of melting zinc salt in water, impregnating it in alumina balls, and then drying and sintering it;
(2) a production method, which is similar to that in European Patent Laid-open Publication No. 1,468,734 but diversified with zinc oxide, zinc hydroxide, zinc carbonate, zinc hydroxy carbonate, etc. being substituted for the zinc compounds; and
(3) a method of producing a catalyst by co-precipitating zinc salt dissolved in water and alumina (aluminium nitrate, aluminium sulfate, aluminium acetate, etc.) salt dissolved in water.

In method (3), a spinel-structured catalyst is made after dissolved salt is adjusted adequate for its pH with sodium carbonate, sodium aluminate and sodium hydrogen carbonate, and then co-precipitated to a hydrotalcite structure, and then cleansed so that the sodium is removed, and then dehydrated, and then heated at 400° C. However, in case a catalyst is produced by using this method, a neutralization process is required and a great amount of waste water is generated because of use of strong acid such as nitric acid, sulfuric acid and acetic acid. Further, in case a catalyst that contains a small amount of nitric acid, sulfuric acid and acetic acid is sintered, air polluting substances such as nitrogen oxide (NOₓ) or sulfur oxide (SO) are generated, which is problematic.

Meanwhile, in case of synthesizing fatty acid alkyl ester by reacting vegetable and animal oil with alcohol with the afore-mentioned catalysts, the percentage of mono-glyceride, which is not involved in the reaction, goes up to 5% at maximum, and thus, it becomes hard to remove mono-glyceride and obtain high-purity fatty acid alkyl ester through simple distillation.

Korean Patent Publication No. 10-0644246, which is for a similar subject matter, discloses a process of producing fatty acid alkyl ester and high-purity glycerin based on a continuous process using a spinel-structured xMgOyZnOZnAl₂O₄ (x=1˜3, y=0˜2) catalyst and several autoclaves. Upon comparing the process in this patent with method (3) for the catalyst production in U.S. Pat. No. 5,908,946 as mentioned earlier, the only difference lies in that not only zinc salt but a mixture of zinc salt and magnesium salt (nitrogen, chlorine, acetate) is used as a catalytic material. A spinel-structured catalyst is produced adding an alkali precipitated aqueous solution (sodium hydroxide, sodium carbonate, sodium hydrogen carbonate) to an aqueous solution of magnesium, aluminium and zinc salt (nitrogen, chlorine, acetate), producing a precipitant in a hydroxide form, and then conducting separation, cleansing, drying and plastic formation. Accordingly, high-purity glycerin can be produced advantageously. However, the purity of the fatty acid alkyl ester is limited to at most 94%, and the percentage of mono-glyceride goes up to maximum 8.7%. Therefore, it becomes hard to remove mono-glyceride to obtain high-purity fatty acid alkyl ester through simple distillation.

In order to solve this problem, European Patent Publication No. 0,924,185 suggests using a zinc aluminate catalyst to practice an ester exchange reaction, splitting into a crude fatty acid alkyl ester layer and a crude glycerin layer, collecting methanol from the crude glycerin and cleansing it, and collecting high-purity fatty acid alkyl ester by a distillation process after practicing a second reaction on the crude fatty acid alkyl ester with the same zinc aluminate catalyst to transform the mono-glyceride inside to di-, tri-glyceride. Through the second reaction, the percentage of the mono-glyceride decreases from 4% to 0.2% or less and thus the purity of the fatty acid alkyl ester increases, but the percentage of the fatty acid alkyl ester also decreases from 91% to 86.9% by 4%. However, the above reaction is performed under a condition of a high temperature of 230° C.˜250° C. and a high pressure of 60 bar˜100 bar, so as to improve the catalyst activity and selectivity. Therefore, a catalyst is essential, which can be handled under a milder reaction condition, to guarantee the reaction stability and a long duration for use.

### SUMMARY OF THE INVENTION

The present invention is achieved to solve the problems mentioned above.

One objective of the present invention is to enable producing fatty acid alkyl ester more conveniently and easily by consistently maintaining a catalyst as heterogeneous and solid so that it is not mixed with the product before or after the reaction. In this regard, the conventional catalyst used to produce fatty acid alkyl ester was a homogeneous one, which was equally mixed with the product produced due to the reaction and thus required for a very complicated separation process.

Another objective is to prevent any product from saponification fundamentally and maximize the efficiency of a process of producing fatty acid alkyl ester. In this regard, this objective is achieved by providing a catalyst that can be maintained as solid in case it is involved in an ester reaction or an ester exchange reaction, which is necessary to produce fatty acid alkyl ester, glycerol, etc., can be produced in a lump such as a pellet or a bead, not in a powder form, with a sufficiently high compression property, and can function in an ester reaction or an ester exchange reaction while not being mixed into the product or at least being mixed only heterogeneously.

Yet another objective is to produce high-purity fatty acid alkyl ester and high-purity glycerin through an exchange reaction between alcohol and ester by using vegetable and animal oil and waste cooking oil, which are more acidic and contain a lot of fatty acid, as well as less acidic vegetable and animal oil, which was refined with a heterogeneous solid catalyst, and to produce high-purity fatty acid alkyl ester through an ester reaction between fatty acid and alcohol.

Still yet another objective is to provide a novel catalyst, which is environment-friendly, easy to produce, and highly qualified, excluding air/water polluting substances such as strong acid and strong alkali.

In order to achieve the afore-mentioned objective, the present invention provides ceramic metal catalyst used for transesterification and esterification for the production of fatty acid alkyl ester and glycerin, which can be obtained from mixing any one of the oxide, carbonate and hydroxide (e.g. MgO, Mg(OH)₂, MgCO₃, etc.) of any one of magnesium (Mg), calcium (Ca), zinc (Zn), titanium (Ti), manganese (Mn), vanadium (V), beryllium (Be), copper (Cu), zirconium (Zr), strontium (Sr), stannum (Sn), barium (Ba), or the combination of more than 2 thereof as catalytic material, whose solid state before and after the reaction is not maintained due to the low compressive strength which requires complicated follow-up purification process in spite of its high catalytic activity, with clays of silica alumina affiliation as support material to make already-settled lumps such as pellets and beads that can keep its solid state of ceramic before and after the reaction, then by sintering the catalytic material and the support material together to produce ceramic metal catalyst with high compressive strength and porosity and whose solid state is maintained before and after the reaction.

The present invention differs from the conventional homogenous catalyst which requires additional catalyst purification and separation process to remove the soap created by the reaction between the catalyst and fatty acids when oils with high fatty acid content are used, on the fact that it enables not only the production of fatty acid alkyl esters from 100% fatty acid for no saponification occurs during the process, but also the production of fatty acid alkyl esters with simple gravity separation from the glycerin because any saponification after the reaction is fundamentally prevented. Therefore, no complicated catalyst purification and separation process is required.

The present invention also differs from the conventional powder type solid catalyst in that this invention provides a highly pressured ceramic catalyst with porosity that keeps its same lump state after the reaction, which does not leave any solid catalyst in the product and thus does not require a very complicated filtration step in the process.

In other words, this invention provides ceramic metal catalyst used for transesterification and esterification for the production of fatty acid alkyl ester and/or glycerol, which can be obtained from mixing catalytic material whose solid state before and after the reaction is not maintained due to the low compressive strength which requires complicated follow-up purification process in spite of its high catalytic activity, with clays of silica alumina affiliation as support material described in the chemical formula 1 below, then by sintering the catalytic material and the support material together to produce ceramic metal catalyst in solid lump form with high compressive strength and porosity. However, silica alumina itself as support material without any catalytic material can also be used as ceramic metal catalyst in this invention.

AlₓSi_{y}O_{z}Mₙ.(H₂O)ₘ Chemical formula 1

wherein

Al=5˜58 wt %, Si=5˜54 wt %, O=20˜65 wt %, H₂O=3˜35 wt %,

M is an impure matter comprising at least one or more of any metallic element except aluminium (Al) and silicon (Si), whose weight ratio is desirably to be maintained no more than M=14 wt % for efficient ceramic production.

The afore-mentioned clay of silica alumina affiliation is not a simple mixture of oxide metal such as Al₂O₃, SiO₂ but silica alumina mixed metal oxide with solid crystal structure, which is a mutually rotated chemical combination of a small amount of metals with Si, Al, and O. These compounds have a bed structure, which is the combination of (SiO₅)ₙ level that shares 3 corners of the tetrahedral SiO₄, and the AlO(OH)₂ level composed of octahedron Al₂O₃, and water may be included between the bed structure. Moreover, a 3 level bed structure may be formed by an AlO(OH)₂ part as center enfolded between two levels of Si₂O₅.

The support material composed of mixed metal oxides is an assembly of natural acid particles which is plastic when moisturized and hardens when dried at the sufficiently high temperature to be sintered to form a solid structure. Thus, when the support material silica alumina is heated with minimum activation energy to be sintered, the body surface combination of AlₓSi_{y}O_{z}Mₙ.(H₂O)ₘ is cut and the surface energy increases higher than the energy inside the powder, and then the powder particles combine with adjacent power particles to cause recombination of each ion to form a ceramic with high porosity and hardness, which differs from pure metal oxides SiO₂ (melting temperature: 1610° C.) and Al₂O₃ (melting temperature: 2000° C.) that are not sintered to form porous structures under the melting temperatures.

The above-mentioned support material already contains metal oxide catalytic material, and thus, only the support material can function as a catalyst but there is an inconvenience that it shows a slower reaction rate. Thus, in order to accelerate the esterification and transesterification, this metal ceramic catalyst invention can be composed of clays of silica aluminium affiliation as the support material included with the catalytic material.

However, if the catalyst collides with the agitator when the ceramic catalyst is agitated in the metal agitator, or if the reacted components stack and because of their weights, the agglomerated catalyst lumps are broken, in other words if the solid catalyst cannot maintain its own solid form, it is difficult for the catalyst to show its advantageous effect. Therefore, it is desirable to limit the content of the active catalytic material in the ceramic metal catalyst from 0.01 wt % to 80 wt % to secure the sufficiently high compressive strength and/or impact strength of the ceramic metal catalyst not to collapse in any circumstances.

However, if the ceramic metal catalyst is used under the reaction circumstances wherein the fluid used for the agitating process is forced-flown, and since there is only minor amount of reacting components inside the reactor, no great external force is applied to the catalyst, the content of the catalytic material can be increased to 90 wt %, and thus, a solid catalyst can be produced that has a more catalytic efficiency in spite of slightly decreased compressive strength.

The above-mentioned catalytic material comprises any one of the oxide, carbonate and hydroxide of any one of magnesium (Mg), calcium (Ca), zinc (Zn), titanium (Ti), manganese (Mn), vanadium (V), beryllium (Be), copper (Cu), zirconium (Zr), strontium (Sr), stannum (Sn), barium (Ba), or the combination of more than 2 thereof.

Furthermore, the ceramic metal catalyst according to the present invention can maintain its sintered state since the support material, silica alumina AlₓSi_{y}O_{z}Mₙ.(H₂O)ₘ combines physicochemically with the catalytic material, in a regular or irregular form. The metal oxide which is a pure catalytic material, is not sintered, singularly or in mixture, into a porous component under its melting temperature, but when sintered with silica alumina AlₓSi_{y}O_{z}Mₙ.(H₂O)ₘ, it becomes a sintered body having a very solid structure and a porous ratio of about 70%.

Below, the method for preparing the ceramic metal catalyst according to the invention will be explained in detail.

As mentioned above, the support material silica alumina (AlₓSi_{y}O_{z}Mₙ.(H₂O)ₘ) and the catalytic material are mixed at a ratio of 100:0˜20:80 in the water. Then, the water is removed by filtration, and the mixture having a predetermined shape such as bead or pellet is made through extrusion, or by totally mixing the powder, plasticizing it by adding water and extruding it. Finally, the ceramic metal catalyst according to the invention is produced by sintering the shaped material at 1000° C.˜1500° C., preferably on 1200° C.˜1350° C., during 2˜24 hours.

Compared to the spinel-structured catalyst of xMgOyZnOZnAl₂O₄ mentioned in the Korean Patent Publication No. 10-0644246 and the spinel-structured catalyst of ZnAl₂O₄, xZnO, yAl₂O₃ mentioned in the U.S. Pat. No. 5,908,946, the above-mentioned ceramic metal catalyst according to the invention is not only completely different on the structural characteristic but also greatly distinct on its method of production. In other words, if the components such as Al₂O₃ mentioned in the Korean Patent Publication No. 10-0644246 or the U.S. Pat. No. 5,908,946, is sintered, the solid sintered body cannot be obtained; for this reason, after making a new compound by using a metallic salt in strong acid, a spinel-structured catalyst can be made through calcination at the temperature of no more than 1000° C. In contrast, the ceramic metal catalyst of the invention is prepared by the method wherein the catalytic material is mixed with the support material, silica alumina (AlₓSi_{y}O_{z}Mₙ.(H₂O)ₘ), and the mixture is plasticized by using water, and then the resulting material is sintered on a high temperature that activates the surface energy. Therefore, the present invention has the advantage to produce the catalyst safely and environment-friendly without atmospheric and water pollution. Furthermore, because the used material is non-toxic, it has the virtue to be safe and harmless to the human body.

Meanwhile, the present invention provides a method for preparing fatty acid alkyl ester comprising the steps of placing the above-mentioned solid state ceramic metal catalyst inside the reactor, maintaining the temperature inside the reactor at 150° C. to 250° C., and the reaction pressure at 5 bar to 50 bar, and performing the transesterification with the equivalence ratio between the content of fatty acid contained in the animal and vegetable oil and the alcohol at 1:1 to 1:15.

Since the solid state catalyst used in the present invention should be separated from the liquid product and maintain still its solid lump form before and after the reaction, it is acceptable to freely use any quantity of the catalyst with considering only the productivity that the more catalyst used, the less product produced. In other words, the product is produced in the form of liquid, meanwhile the catalyst stays in a solid lump form even after the reaction. Thus, the catalyst can be separated from the products by simple filtration. In case where this filtering process must be removed in the method for producing fatty acid alkyl ester, a catalyst-free product can be obtained when discharging the products after the reaction by fixing the catalyst inside the reactor beforehand.

Through this transesterification is produced the fatty acid alkyl ester of a high purity, and according to the reaction scheme as shown in the FIG. 4, it is possible to produce high-purity fatty acid alkyl ester as well as high-purity glycerin through the reaction between alcohol and oil contained in the animal and vegetable oil under the action of the solid state catalyst. Here, the above-mentioned reactor must be maintained at the temperature of 180° C. to 220° C., and the pressure inside the reactor at 20 bar to 40 bar.

Furthermore, as the above-mentioned animal and vegetable oils, those having fatty acid can be used, and also, can be used soybean oil, rape seed oil, sunflower oil, palm oil, corn oil, cottonseed oil, castor oil, Jatropha oil, coconut oil, palm seed oil, fish oil, beef tallow, pork lard, and any waste cooking oils from these, and the mixture of at least two of these. Moreover, as the above-mentioned alcohol, can be used any lower alcohol with 1 to 4 carbon atoms such as methanol, ethanol, propanol, butanol or higher alcohol such as 2-ethyl hexanol, or a combination of at least two alcohols mentioned above.

In the present invention, the reaction temperature must be maintained between 150° C.˜250° C. If the reaction temperature drops below 150° C., the rate of the fatty acid esterification decreases, and if the reaction temperature exceeds 250° C., too much of unnecessary heat is generated and the energy consumption increases which is not preferred.

The transesterification is performed on a fixed bed reactor or on a continuous reactor with more than one autoclave and one discontinuously structured autoclave reactor, and the above-mentioned reaction temperature, pressure, and equivalence ratio between the content of oil and the alcohol vary depending on the used raw material. This reaction conditions concur with the conversion conditions of the ester in fatty acid included in the oils, and the fatty acid is converted into ester during the reaction.

Meanwhile, the present invention provides the method to produce fatty acid alkyl ester by esterification of pure fatty acid obtained from afore-mentioned oils and alcohol using the above-mentioned ceramic metal catalyst. In other words, the present invention provides the method for preparing fatty acid alkyl ester comprising placing the solid state ceramic metal catalyst inside the reactor, maintaining the temperature inside the reactor at 120° C. to 250° C., and the reaction pressure at 5 bar to 50 bar, and converting the fatty acid into ester by transesterification with the equivalence ratio between the content of fatty acid and the alcohol at 1:1 to 1:15.

Since the solid state catalyst used herein should be separated from the liquid product and maintain still its solid lump form before and after the reaction, it is acceptable to freely use any quantity of the catalyst with considering only the productivity that the more catalyst used, the less product produced. In other words, the product is produced in the form of liquid, meanwhile the catalyst remains in a solid lump form even after the reaction. Therefore, the catalyst can be separated from the products by carrying out simple filtration. If this filtering process is intended to be removed in the method for producing fatty acid alkyl ester, a catalyst-free product can be obtained when discharging the products after the reaction by fixing the catalyst inside the reactor beforehand.

Furthermore, the above-mentioned reactor must maintain its temperature at 130° C. to 220° C., and its pressure at 10 bar to 40 bar in order to have the best efficiency to produce high-purity fatty acid alkyl ester.

In the invention, the reaction temperature must be maintained between 120° C.˜250° C. If the reaction temperature drops below 120° C., the rate of the fatty acid esterification decreases, and if the reaction temperature exceeds 250° C., too much of unnecessary heat is generated and the energy consumption increases which is not preferred.

Furthermore, the above-mentioned fatty acid can be those prepared from at least one of soybean oil, rape seed oil, sunflower oil, palm oil, corn oil, cottonseed oil, castor oil, Jatropha oil, coconut oil, palm seed oil, fish oil, beef tallow, pork lard, and any waste cooking oils from these, and the mixture of at least two of these. Moreover, as the above-mentioned alcohol, can be used any lower alcohol with 1 to 4 carbon atoms such as methanol, ethanol, propanol, butanol or higher alcohol such as 2-ethyl hexanol, or a combination of at least two alcohols mentioned above.

The esterification is carried out on a fixed bed reactor or on a continuous or discontinuous autoclave system. The reaction temperature, pressure, fatty acid and equivalence ratio between the content of oil and the alcohol vary depending on the raw material conditions.

### EFFECT

As explained above, the present invention provides a new conceptual solid or powder state ceramic metal catalyst. The catalyst can be obtained by a method comprising using the mixed metal oxide, silica alumina as support material, mixing it with at least one of oxide, carbonate and hydroxide of any one of magnesium (Mg), calcium (Ca), zinc (Zn), titanium (Ti), manganese (Mn), vanadium (V), beryllium (Be), copper (Cu), zirconium (Zr), strontium (Sr), stannum (Sn) or barium (Ba) as a catalytic material at 0 wt % to 80 wt %, and then sintering them to create a solid ceramic metal catalyst having a high hardness. The present invention also provides a method to prepare high-purity fatty acid alkyl ester without any catalyst removal or purification process comprising fixing the ceramic metal catalyst as prepared above inside the reactor, and performing the ester exchange reaction or esterification of the animal and vegetable oil and alcohol.

Furthermore, the new high-performing heterogeneous solid ceramic metal catalyst provided by the present invention differs from the conventional heterogeneous solid catalyst on the fact that it excludes the use of air/water polluting components such as strong acid and strong base, which makes it an easily-produced, environment-friendly catalyst. Also the method provided by the present invention differs from the conventional method in that fatty acid alkyl ester is prepared without going through any catalyst removal or purification process.

In other words, the present invention allows to produce both high-purity fatty acid alkyl ester and high-purity glycerin by reacting animal and vegetable oils and alcohol using the above-mentioned solid state ceramic metal catalyst.

### DETAILED DESCRIPTION

The present invention will now be described in detail with reference to the specific embodiments and the accompanied drawings below, although detailed description on the functions or structures well known in the art will be abridged to clarify the main point of the present invention.

Furthermore, the M component contained in the silica alumina is a minor amount of at least one metal component, and even if the type of the M component changes or is slightly different in the content, it does not affect the final product of ceramic metal catalyst and its activity or its compressive strength. Therefore, in order to clarify the main point of the invention, details and the enumeration of the minor amount of metal components of the M component of silica alumina will be abridged.

First, a method to prepare the ceramic metal catalyst according to the present invention will be described in detail.

### Example 1

### Production of Ceramic Metal Catalyst for Transesterification or Esterification 1

Using the magnesium oxide (MgO) as catalytic material and the mixed metal oxide silica alumina AlₓSi_{y}O_{z}Mₙ.(H₂O)ₘ (Al=22%, Si=20%, O=43%, M=1%, H₂O=14%) as support material, the ceramic metal catalyst was produced at a different ratio of catalytic material and support material. As shown in Table 1, with changing their weight ratio, the support material and the catalytic material were mixed homogeneously in 200 ml of water. The homogeneously mixed solution of colloid went through filtration, and after the water was removed, a catalyst in the form of beads with a diameter of 5 mm was produced by extrusion. By sintering the produced catalyst in the bead form during 4 hours at 1250° C., ceramic metal catalyst with high compressive strength was obtained.

TABLE 1

| Ex- | Support | Catalytic | Catalyst | | Compressive |
|---|---|---|---|---|---|
| ample | material | material | diameter | Density | strength |
| 1-1 | AlₓSi_{y}O_{z}Mₙ•(H₂O)ₘ | MgO | 5 mm | 0.987 | 121 kg/cm² |
| | 100 g | 0 g | | | |
| 1-2 | AlₓSi_{y}O_{z}Mₙ•(H₂O)ₘ | MgO | 5 mm | 0.625 | 95 kg/cm² |
| | 50 g | 50 g | | | |
| 1-3 | AlₓSi_{y}O_{z}Mₙ•(H₂O)ₘ | MgO | 5 mm | 0.578 | 76 kg/cm² |
| | 20 g | 80 g | | | |

As shown in Table 1, as the weight proportion of the catalytic material increases, even if it promotes the esterification as in FIG. 3 and FIG. 4, the compressive strength decreases. Thus, the content of the catalytic material should not exceed 80 wt % of the ceramic metal catalyst to secure the sufficiently high compressive strength so that the solid state ceramic metal catalyst fixed inside the reactor does not get homogeneously mixed in the reacting substance.

### Comparative Example 1

### In Case of Using Pure Metal Oxide as Support Material

By mixing homogeneously 50 g of magnesium oxide (MgO) with 50 g of a single metal oxide or mixture of pure metal oxides as the support material in 200 ml of water on a certain proportion, and then filtering the mixed solution to remove the water, a catalyst was obtained in the form of beads with a diameter of 5 mm after extrusion. By sintering the produced catalyst of the bead form during 4 hours at 1250° C., the desired catalyst was obtained. As shown in Table 2, the support material and catalytic material were sintered in the catalyst thus produced, and thus, it is not possible to prepare any solid sintered body catalyst. Therefore, it cannot be used as a heterogeneous solid catalyst.

TABLE 2

| Comparative | Support | Catalytic | Catalyst | | |
|---|---|---|---|---|---|
| Example | material | material | diameter | Density | Note |
| 2-1 | Al₂O₃ | — | 5 mm | 0.89 | No |
| | 50 g | | | | sintering |
| 2-2 | SiO₂ | — | 5 mm | — | No |
| | 50 g | | | | sintering |
| 2-3 | Al₂O₃SiO₂ | — | 5 mm | — | No |
| | 50 g | | | | sintering |
| 2-4 | Al2O3 | MgO | 5 mm | 0.55 | No |
| | 50 g | 50 g | | | sintering |
| 2-5 | SiO₂ | MgO | 5 mm | 0.53 | No |
| | 50 g | 50 g | | | sintering |
| 2-6 | Al₂O₃SiO₂ | MgO | 5 mm | 0.54 | No |
| | 50 g | 50 g | | | sintering |

### Comparative Example 2

### In Case that the Weight Ratio of the Active Catalyst Exceeds 80 Wt %

By mixing homogeneously 50 g magnesium oxide (MgO) and the silica alumina AlₓSi_{y}O_{z}Mₙ.(H₂O)ₘ (Al=22%, Si=20%, O=43%, M=1%, H₂O=14%) in 200 ml of water, and then filtering the colloid solution to remove the water, a catalyst was produced in the form of beads with a diameter of 5 mm after extrusion. By sintering the produced catalyst of the bead form during 4 hours at 1250° C., the ceramic metal catalyst was obtained. Consequently, as it appears in Table 3, the support material and catalytic material were not sintered or even if they were sintered, the compressive strength was too low; therefore it could not be used as a heterogeneous solid catalyst.

TABLE 3

| Compar- | | Cata- | Catalyst | | Com- |
|---|---|---|---|---|---|
| ative | Support | lytic | diam- | | pressive |
| example | material | material | eter | Density | strength |
| 3-1 | AlₓSi_{y}O_{z}Mₙ•(H₂O)ₘ | MgO | 5 mm | — | No |
| | 0 g | 100 g | | | sintering |
| 3-2 | AlₓSi_{y}O_{z}Mₙ•(H₂O)ₘ | MgO | 5 mm | 0.474 | <=5 kg/cm² |
| | 5 g | 95 g | | | |
| 3-3 | AlₓSi_{y}O_{z}Mₙ•(H₂O)ₘ | MgO | 5 mm | 0.513 | <=5 kg/cm² |
| | 10 g | 90 g | | | |

### Example 2

### Production of Ceramic Metal Catalyst for Transesterification or Esterification 2

After mixing homogeneously 50 g of the catalytic material magnesium oxide (MgO), and 50 g of the support material silica alumina AlₓSi_{y}O_{z}Mₙ.(H₂O)ₘ (Al=22%, Si=20%, O=43%, M=1%, H₂O=14%) in powder state, and adding a predetermined amount of water to plasticize it, a catalyst could be obtained in the form of beads with a diameter of 5 mm after extrusion. By sintering the produced catalyst of the bead form during 4 hours at 1250° C., the ceramic metal catalyst was obtained.

TABLE 4

| Ex- | Support | Catalytic | Catalyst | | Compressive |
|---|---|---|---|---|---|
| ample | material | material | diameter | Density | strength |
| 4-1 | AlₓSi_{y}O_{z}Mₙ•(H₂O)ₘ | MgO | 5 mm | 0.625 | 92 kg/cm² |
| | 50 g | 50 g | | | |

In other words, after mixing the support material and the catalytic material in powder form, adding water to plasticize it, and then extruding it, there could obtain a ceramic metal catalyst according to the present invention by using the method other than in the Example 1.

### Example 3

### Production of Ceramic Metal Catalyst for Transesterification or Esterification 3

Using 50 g of magnesium carbonate (MgCO₃) or magnesium hydroxide (Mg(OH)₂) as catalytic material and 50 g of mixed metal oxide silica alumina AlₓSi_{y}O_{z}Mₙ.(H₂O)ₘ (Al=22%, Si=20%, O=43%, M=1%, H₂O=14%) as support material, the support material and the catalytic material were mixed homogeneously in 200 ml of water. The homogeneously mixed solution of colloid went through filtration, and after the water was removed, a catalyst was produced in the form of beads with a diameter of 5 mm by extrusion. By sintering the produced catalyst of the bead form during 4 hours at 1250° C., the ceramic metal catalyst with high compressive strength was obtained.

TABLE 5

| Ex- | Support | Catalytic | Catalyst | | Compressive |
|---|---|---|---|---|---|
| ample | material | material | diameter | Density | strength |
| 5-1 | AlₓSi_{y}O_{z}Mₙ•(H₂O)ₘ | MgCO₃ | 5 mm | 0.609 | 88 kg/cm² |
| | 50 g | 50 g | | | |
| 5-2 | AlₓSi_{y}O_{z}Mₙ•(H₂O)ₘ | Mg(OH)₂ | 5 mm | 0.612 | 96 kg/cm² |
| | 50 g | 50 g | | | |

As can be confirmed in Table 5, the carbonate or hydroxide of any one of magnesium (Mg), calcium (Ca), zinc (Zn), titanium (Ti), manganese (Mn), vanadium (V), beryllium (Be), copper (Cu), zirconium (Zr), strontium (Sr), stannum (Sn), and barium (Ba) can be used as a catalytic material.

### Example 4

### Production of Ceramic Metal Catalyst for Transesterification or Esterification 4

Using 50 g of oxides of CaO, ZnO, MnO, or TiO₂ as catalytic material, and 50 g of mixed metal oxide silica alumina AlₓSi_{y}O_{z}Mₙ.(H₂O)ₘ (Al=22%, Si=20%, O=43%, M=1%, H₂O=14%) as support material, they were mixed homogeneously in 200 ml of water. The homogeneously mixed solution went through filtration, and after the water was removed, a catalyst was produced in the form of beads with a diameter of 5 mm by extrusion. By sintering the produced catalyst of the bead form during 4 hours at 1250° C., the ceramic metal catalyst with high compressive strength was obtained.

TABLE 6

| Ex- | Support | Catalytic | Catalyst | | Compressive |
|---|---|---|---|---|---|
| ample | material | material | diameter | Density | strength |
| 6-1 | AlₓSi_{y}O_{z}Mₙ•(H₂O)ₘ | CaO | 5 mm | 0.618 | 101 kg/cm² |
| | 50 g | 50 g | | | |
| 6-2 | AlₓSi_{y}O_{z}Mₙ•(H₂O)ₘ | ZnO | 5 mm | 0.614 | 89 kg/cm² |
| | 50 g | 50 g | | | |
| 6-3 | AlₓSi_{y}O_{z}Mₙ•(H₂O)ₘ | MnO | 5 mm | 0.622 | 87 kg/cm² |
| | 50 g | 50 g | | | |
| 6-4 | AlₓSi_{y}O_{z}Mₙ•(H₂O) ₘ | TiO₂ | 5 mm | 0.612 | 98 kg/cm² |
| | 50 g | 50 g | | | |

As can be confirmed in Table 6, the oxide of any one of magnesium (Mg), calcium (Ca), zinc (Zn), titanium (Ti), manganese (Mn), vanadium (V), beryllium (Be), copper (Cu), zirconium (Zr), strontium (Sr), stannum (Sn), and barium (Ba) can be used as catalytic material.

### Example 5

### Production of Ceramic Metal Catalyst for Transesterification or Esterification 5

Using 50 g of a mixture including at a specific ratio two or more oxides selected from CaO, ZnO, MnO, and TiO₂ as catalytic material, and 50 g of mixed metal oxide silica alumina AlₓSi_{y}O_{z}Mₙ.(H₂O)ₘ (Al=22%, Si=20%, O=43%, M=1%, H₂O=14%) as support material, they were mixed homogeneously in 200 ml of water. The homogeneously mixed solution went through filtration, and after the water was removed, a catalyst was produced in the form of beads with a diameter of 5 mm by extrusion. By sintering the produced catalyst of the bead form during 4 hours at 1250° C., the ceramic metal catalyst with high compressive strength was obtained.

TABLE 7

| | | | | Catalyst | | Com- |
|---|---|---|---|---|---|---|
| Ex- | Support | Catalytic | | diam- | Den- | pressive |
| ample | material | material | | eter | sity | strength |
| 7-1 | AlₓSi_{y}O_{z}Mₙ•(H₂O)ₘ | MgO + | 45 g | 5 mm | 0.613 | 97 kg/cm² |
| | 50 g | ZnO | 5 g | | | |
| 7-2 | AlₓSi_{y}O_{z}Mₙ•(H₂O)ₘ | MgO + | 45 g | 5 mm | 0.619 | 102 kg/cm² |
| | 50 g | MnO | 5 g | | | |
| 7-3 | AlₓSi_{y}O_{z}Mₙ•(H₂O)ₘ | MgO + | 45 g | 5 mm | 0.616 | 99 kg/cm² |
| | 50 g | TiO₂ | 5 g | | | |
| 7-4 | AlₓSi_{y}O_{z}Mₙ•(H₂O)ₘ | MgO + | 40 g | 5 mm | 0.621 | 89 kg/cm² |
| | 50 g | ZnO + | 5 g | | | |
| | | TiO₂ | 5 g | | | |

As can be confirmed in Table 7, a mixture of two or more oxides of magnesium (Mg), calcium (Ca), zinc (Zn), titanium (Ti), manganese (Mn), vanadium (V), beryllium (Be), copper (Cu), zirconium (Zr), strontium (Sr), stannum (Sn), and barium (Ba) can be used as catalytic material.

### Example 6

### Transesterification 1

A fatty acid alkyl ester was produced through transesterification as shown in FIG. 4 by using the autoclave (1) as illustrated in FIG. 1. The solid-state ceramic metal catalysts 1-1, 1-2, 1-3 produced according to Example 1 were supplied through the pipe (11) in the 300 ml autoclave (1). After filling and fixing 13.9 g of the catalyst into the basket made of 1 mm mesh in the autoclave agitator, 160 ml of soybean oil having an acid value of 100 was supplied through the pipe (12), and 80 ml of methanol through the pipe (13). Then, the autoclave (1) was heated with the heater (14) to set the temperature at 200° C. After 1 hour of heating, the reaction continued during 3 hours. After the end of the reaction, the product was discharged through the exit pipe (15), and then the methanol was vaporized through evaporation, and finally the fatty acid methyl ester was produced after separating it from the glycerin. The fatty acid methyl ester product was analyzed by gas chromatography to indicate its purity as weight by %, and the acid value was measured by the acid-base titration. The analyzed results were summarized as follows.

TABLE 8

| | | Purity (%) | | | | |
|---|---|---|---|---|---|---|
| | | Fatty | | | | |
| | Catalyst | acid | Mono- | Di- | Tri- | |
| | type | methyl | glycer- | glycer- | glycer- | Acid |
| Example | used | ester | ide | ide | ide | value |
| 8-1 | 1-1 | 96.6 | 3.0 | 0.3 | 0.1 | 0.49 |
| | catalyst | | | | | |
| | from ex. | | | | | |
| | 1 | | | | | |
| 8-2 | 1-2 | 98.4 | 1.6 | 0 | 0 | 0.46 |
| | catalyst | | | | | |
| | from ex. | | | | | |
| | 1 | | | | | |
| 8-3 | 1-3 | 98.8 | 1.2 | 0 | 0 | 0.47 |
| | catalyst | | | | | |
| | from ex. | | | | | |
| | 1 | | | | | |

As can be seen in Table 8, using the ceramic metal catalyst produced in Example 1, and injecting the animal and vegetal oils as oil, and methanol as alcohol, the inventors obtained, as the result of the transesterification at 200° C., 96.6% to 98.8% pure fatty acid alkyl ester. Here, since the used ceramic metal catalyst was fixed inside the autoclave (1) in solid state, the catalyst was not contained in the product. Therefore, it is not necessary to separate the catalyst from the product, which simplifies the process.

Although a discontinuous transesterification can be done in the autoclave, the transesterification can be carried out continuously by transesterifying the product obtained in one autoclave in another autoclave, using continuously installed autoclaves.

### Example 7

### Transesterification 2

The inventors produced fatty acid methyl ester with the solid state ceramic metal catalyst 1-2 produced according to Example 1, supplied through the pipe (11) in the 300 ml autoclave (1). After filling and fixing 13.9 g of the catalyst into the basket made of 1 mm mesh in the autoclave agitator, 160 ml of soybean oil having an acid value of 10 was supplied as the oil through the pipe (12), and 80 ml of methanol supplied as the alcohol through the pipe (13). Then, the autoclave (1) was heated with the heater (14) to set the temperature inside the autoclave to different temperatures of 160° C., 180° C., 200° C., and 220° C. After heating the autoclave for 1 hour at such temperatures, the reaction continued for 3 hours. After the end of the reaction, the methanol was vaporized through evaporation, and finally the fatty acid methyl ester was produced after separating it from the glycerin. The fatty acid methyl ester product was analyzed by gas chromatography to indicate its purity as weight by %, and the acid value was measured by the acid-base titration. The analyzed results were summarized in Table 9.

TABLE 9

| | | | Purity (%) | | | | |
|---|---|---|---|---|---|---|---|
| | | | Fatty | | | | |
| | | Pres- | acid | Mono- | Di- | Tri- | |
| | | sure | methyl | glycer- | glycer- | glycer- | Acid |
| Example | Temp. | (bar) | ester | ide | ide | ide | value |
| 9-1 | 160° C. | 17 | 96.0 | 2.9 | 0.3 | 0.1 | 0.77 |
| 9-2 | 180° C. | 25 | 97.1 | 2.3 | 0 | 0 | 0.50 |
| 9-3 | 200° C. | 30 | 98.0 | 1.3 | 0 | 0 | 0.46 |
| 9-4 | 220° C. | 37 | 98.6 | 0.8 | 0 | 0 | 0.44 |

As can be seen in Table 9, the inventors confirmed that when the transesterification was carried out at the various temperature ranging from 160° C. to 220° C. by using the ceramic metal catalyst produced in Example 1, and injecting the animal and vegetal oils as oil, and methanol as alcohol, the fatty acid alkyl ester having the purity of at least 97% could be obtained through the transesterification at 180° C. to 220° C.

### Example 8

### Transesterification 3

The inventors produced fatty acid methyl ester with the solid state ceramic metal catalyst produced according to Examples 2 to 5, supplied through the pipe (11) in the 300 ml autoclave (1). After filling and fixing 13.9 g of the catalyst into the basket made of 1 mm mesh in the autoclave agitator, 160 ml of soybean oil having an acid value of 10 was supplied through the pipe (12), and 80 ml of methanol supplied as the alcohol through the pipe (13). Then, the autoclave (1) was heated with the heater (14) to set the temperature at 200° C. After 1 hour of heating, the reaction continued during 3 hours. After the end of the reaction, the methanol was removed through evaporation, and finally the fatty acid methyl ester was produced after separating it from the glycerin. The fatty acid methyl ester product was analyzed by gas chromatography to indicate its purity as weight by %, and the acid value was measured by the acid-base titration. The analyzed results were summarized in Table 10.

TABLE 10

| | | Purity (%) | | | | |
|---|---|---|---|---|---|---|
| | | Fatty | | | | |
| | Catalyst | acid | Mono- | Di- | Tri- | |
| | type | methyl | glycer- | glycer- | glycer- | Acid |
| Example | used | ester | ide | ide | ide | value |
| 10-1 | Example | 98.2 | 1.2 | 0.1 | 0 | 0.38 |
| | 2-1 | | | | | |
| 10-2 | Example | 97.1 | 2.1 | 0.2 | 0 | 0.50 |
| | 3-1 | | | | | |
| 10-3 | Example | 97.5 | 1.8 | 0.1 | 0 | 0.42 |
| | 3-2 | | | | | |
| 10-4 | Example | 96.6 | 2.1 | 0.5 | 0 | 0.39 |
| | 4-1 | | | | | |
| 10-5 | Example | 97.6 | 2.0 | 0 | 0 | 0.44 |
| | 4-2 | | | | | |
| 10-6 | Example | 96.9 | 1.4 | 0.4 | 0 | 0.48 |
| | 4-3 | | | | | |
| 10-7 | Example | 97.1 | 2.0 | 0.3 | 0 | 0.42 |
| | 4-4 | | | | | |
| 10-8 | Example | 98.0 | 1.4 | 0 | 0 | 0.44 |
| | 5-1 | | | | | |
| 10-9 | Example | 97.3 | 2.0 | 0.1 | 0 | 0.46 |
| | 5-2 | | | | | |
| 10-10 | Example | 97.7 | 1.7 | 0 | 0 | 0.43 |
| | 5-3 | | | | | |
| 10-11 | Example | 98.0 | 1.4 | 0 | 0 | 0.41 |
| | 5-4 | | | | | |

As can be seen in Table 10, the inventors confirmed that the fatty acid alkyl ester having the purity of at least 96.6% could be obtained through the transesterification using the ceramic metal catalyst produced in Examples 2 to 5.

### Example 9

### Transesterification 4

The inventors produced high-purity fatty acid alkyl ester through transesterification as shown in FIG. 4 by using the fixed bed reactor (1) as shown in FIG. 2 and the ceramic metal catalyst 1-2 produced in Example 1. After homogeneously mixing the soybean oil in the agitator (110), and heating up the oil through the pipe (111) in order to reach its predetermined temperature, the oil was supplied at the flow rate of 6 ml/min to the high pressure tubular fixed bed reactor (120) with a diameter of 5 cm and a length of 150 cm which was maintained at the temperature of 200° C., and the solid-state ceramic metal catalysts produced in Examples and 2 were fixed therein. Then, the fixed bed reactor (120) was supplied with methanol at the flow rate of 3 ml/min.

The product produced by the transesterification in the fixed bed reactor (120), was gathered in product storage (130) through the pipe (121). Then, when the level gauge (131) sensed the gathered product, the valve (141) was opened to transfer it from the product storage (130) to the final product storage (140). Thereafter, in this final product storage (140), the fatty acid alkyl ester and the glycerin were separated by gravity. At the same time, the methanol contained in the product in the product storage (130) was separated and stocked in the methanol storage (154) by controlling the pump (151) and the pressure controlling valve (152) and cooling it down through the cooler (153). The fatty acid methyl ester as the final product was analyzed by gas chromatography to indicate its purity as weight by %, and the acid value was measured by the acid-base titration. The analyzed results were summarized in Table 11.

TABLE 11

| | | Purity (%) | | | | |
|---|---|---|---|---|---|---|
| | | Fatty | | | | |
| | Reaction | acid | Mono- | Di- | Tri- | |
| | time | methyl | glycer- | glycer- | glycer- | Acid |
| Example | (min) | ester | ide | ide | ide | value |
| 11-1 | 120 | 97.7 | 1.7 | 0 | 0 | 0.43 |

As can be seen in Table 11, the fatty acid alkyl ester having the purity of at least 97.7% could be obtained not only in the autoclave but also in the fixed bed reactor through the transesterification by using the ceramic metal catalyst produced in Example 1, 1-2 and injecting the animal and vegetal oils as oil, and methanol as alcohol. In the same manner, since the used ceramic metal catalyst was fixed in a solid state inside the fixed bed reactor (120), the catalyst was not contained in the product. Therefore, it is not necessary to separate the catalyst from the product, which simplifies the process.

Furthermore, although a discontinuous transesterification can be done in the fixed bed reactor, the transesterification can be performed in a continuous multistage mode by transesterifying the product obtained in one fixed bed reactor in another fixed bed reactor, using continuously installed fixed bed reactor.

### Example 10

### Transesterification 5

The inventors produced fatty acid methyl ester with the solid state ceramic metal catalyst 1-2 produced according to Example 1, supplied through the pipe (11) in the 300 ml autoclave (1). After filling and fixing 13.9 g of the catalyst into the basket made of 1 mm mesh in the autoclave agitator, 160 ml of soybean oil having an acid value of 100 was supplied through the pipe (12), and 80 ml of methanol supplied as the alcohol through the pipe (13). Then, the autoclave (1) was heated with the heater (14) to set the temperature at 200° C. After heating the autoclave for 1 hour at such temperature, the reaction continued during 2 hours. After the end of the reaction, the methanol was removed through evaporation, and the glycerin was separated from the water. At this time, since the soybean oil contains not only oil but also fatty acid, water is produced with glycerin, and thus, they are removed together by gravity separation. After supplying an additional 80 ml of methanol as alcohol, the inside was heated up at 200° C. for 1 hour. Then, the methanol was removed through evaporation, and glycerin and water was removed by gravity separation to obtain the fatty acid methyl ester. The fatty acid methyl ester product was analyzed by gas chromatography to indicate its purity as weight by %, and the acid value was measured by the acid-base titration. The analyzed results were summarized in Table 12.

TABLE 12

| | | Purity (%) | | | | |
|---|---|---|---|---|---|---|
| | | Fatty | | | | |
| | | acid | | Di- | Tri- | |
| | Reaction | methyl | Fatty | glycer- | glycer- | Acid |
| Example | step | ester | acid | ide | ide | value |
| 12-1 | First | 78.6 | 11.3 | 2.6 | 0.4 | 13.5 |
| | reaction | | | | | |
| 12-2 | Second | 90.0 | 2.3 | 0 | 0 | 4.2 |
| | reaction | | | | | |
| 12-3 | Third | 98.3 | 1.3 | 0 | 0 | 0.58 |
| | reaction | | | | | |

As can be seen in Table 12, although the reaction in the autoclave can end after a single transesterification, in order to produce a purer product, the inventors performed a multistage reaction. As a result, after the 3^{rd} reaction, a 98.3% high-purity fatty acid methyl ester was obtained, whereas after the 1^{st} reaction, the product only showed 78.6% purity.

### Example 11

### Esterification 1

The inventors produced high-purity fatty acid alkyl ester through esterification as shown in FIG. 3 by using the autoclave (1) as shown in FIG. 1. The solid-state ceramic metal catalyst 1-2 produced according to Example 1, was supplied through the pipe (11) inside the 300 ml autoclave (1). After filling and fixing 13.9 g of the catalyst into the basket made of 1 mm mesh in the autoclave (1) agitator, 160 ml of fatty acid containing 45% fatty acid methyl ester was supplied through the pipe (12), and 80 ml of methanol supplied as the alcohol through the pipe (13). Then, the autoclave (1) was heated with the heater (14) to set the temperature at 200° C. After heating the autoclave for 1 hour at such temperature, the reaction continued during 3 hours. After the end of the reaction, the methanol was removed through evaporation, and water was removed by gravity separation. After supplying additional 80 ml of methanol as alcohol, the inside was heated up at 200° C. for 1 hour. Then, the methanol was removed through evaporation, and water was removed by gravity separation to obtain the fatty acid methyl ester. The fatty acid methyl ester product was analyzed by gas chromatography to indicate its purity as weight by %, and the acid value was measured by the acid-base titration. The analyzed results were summarized in Table 13.

TABLE 13

| | | Purity (%) | | |
|---|---|---|---|---|
| | Reaction | Fatty acid | | Acid |
| Example | step | methyl ester | Fatty acid | value |
| 13-1 | First | 92.3 | 7.3 | 14.6 |
| | reaction | | | |
| 13-2 | Second | 96.7 | 2.9 | 5.8 |
| | reaction | | | |
| 13-3 | Third | 99.3 | 0.31 | 0.62 |
| | reaction | | | |

As can be seen in Table 13, a 99.3% pure fatty acid methyl ester could be produced through esterification from a fatty acid containing 45% fatty acid methyl ester. Moreover, the purity of the fatty acid methyl ester produced from 92.3% at the first reaction was improved to 99.3% after the third reaction.

### Example 12

### Esterification 2

The present inventors produced high-purity fatty acid alkyl ester through esterification as shown in FIG. 3 by using the autoclave (1) as shown in FIG. 1. The solid-state ceramic metal catalyst 1-2 produced according to Example 1, was supplied through the pipe (11) in the 300 ml autoclave (1). After filling and fixing 13.9 g of the catalyst into the basket made of 1 mm mesh in the autoclave (1) agitator, 160 ml of a soybean fatty acid as a fatty acid for reaction was supplied through the pipe (12), and 80 ml of methanol supplied as the alcohol through the pipe (13). Then, the autoclave (1) was heated with the heater (14) to set the temperature at 200° C. After heating the autoclave for 1 hour at such temperature, the reaction continued during 3 hours. After the end of the reaction, the methanol was removed through evaporation, and water was removed by gravity separation. After supplying additional 80 ml of methanol, the inside was heated up at 200° C. for 1 hour and the second reaction was continued during 3 hours. After the end of the second reaction, a third reaction was performed by using the same method, and the methanol of the final product was removed through evaporation, and water was removed by gravity separation to obtain the fatty acid methyl ester. The fatty acid methyl ester product was analyzed by gas chromatography to indicate its purity as weight by %, and the acid value was measured by the acid-base titration. The analyzed results were summarized in Table 14.

TABLE 14

| | | Purity (%) | | |
|---|---|---|---|---|
| | Reaction | Fatty acid | | Acid |
| Example | step | methyl ester | Fatty acid | value |
| 14-1 | First | 91.6 | 8.0 | 16.0 |
| | reaction | | | |
| 14-2 | Second | 96.3 | 3.3 | 6.6 |
| | reaction | | | |
| 14-3 | Third | 99.3 | 0.35 | 0.7 |
| | reaction | | | |

As can be seen in Table 14, a 99.3% high-purity fatty acid methyl ester was obtained from fatty acid from animal and vegetable oils such as soybean oil containing a fatty acid using a multistage esterification.

As seen and proved above, the present invention allows to create high-purity fatty acid alkyl ester and high-purity glycerin through an transesterification between animal and vegetable oils and alcohol using the porous solid state ceramic metal catalyst, wherein the catalyst is produced by mixing the solid crystal structured support material silica alumina with the catalytic material of any one of oxide, carbonate and hydroxide of any one of magnesium (Mg), calcium (Ca), zinc (Zn), titanium (Ti), manganese (Mn), vanadium (V), beryllium (Be), copper (Cu), zirconium (Zr), strontium (Sr), stannum (Sn) or barium (Ba). Thus, the use of such catalyst allows to skip the catalyst removal and purification process, which simplifies the process. Furthermore, high-purity fatty acid alkyl ester can be produced through an esterification between fatty acid and alcohol.

Furthermore, unlike the heterogeneous catalyst of the prior art, the catalyst shown in the present invention has the advantage that the catalyst is environment-friendly, and promotes the efficiency in the production of fatty acid alkyl ester.

Although the preferred embodiments of the invention have been described above for illustration, it should be understood that the invention as claimed should not be unduly limited to such specific embodiments. Indeed, various modifications of the invention will be apparent to those of ordinary skill in the art and are intended to be within the scope of the following claims.

### BRIEF DESCRIPTION OF THE FIGURES

FIG. 1 is a schematic figure of continuous or discontinuous CSTR (Continuous stirred tank reactor) system to make fatty acid alkyl ester using the ceramic catalyst according to the present invention.

FIG. 2 is a schematic figure of continuous PFR (Plug Flow reactor) system to make fatty acid alkyl ester using the ceramic catalyst according to the present invention.

FIG. 3 is the reaction scheme of the esterification used for the production of fatty acid alkyl ester according to the present invention.

FIG. 4 is the reaction scheme of the transesterification used for the production of fatty acid alkyl ester according to the present invention.

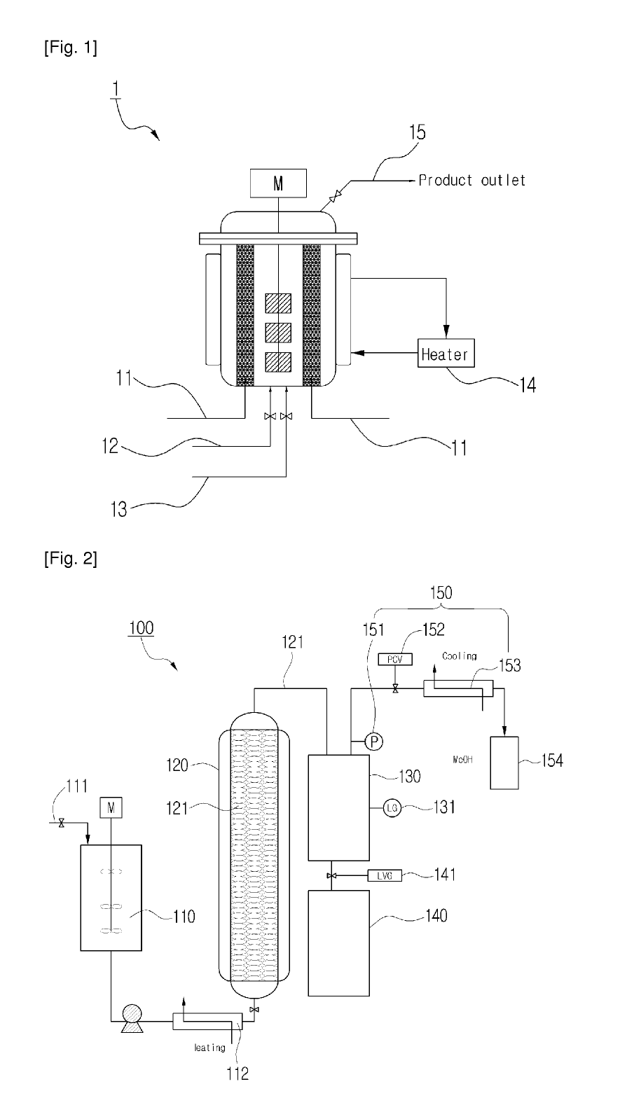

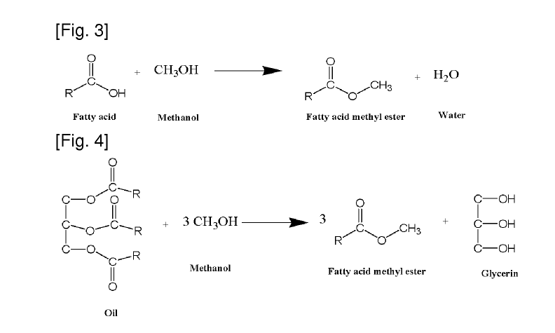

1-22. (canceled)

23. A ceramic metal catalyst used for transesterification and esterification formed by sintering clay of silica alumina affiliation.

24. The ceramic metal catalyst of claim 23, comprising an active catalytic material formed with at least one selected from the oxide, the carbonate and the hydroxide of at least one selected from magnesium (Mg), calcium (Ca), zinc (Zn), titanium (Ti), manganese (Mn), vanadium (V), beryllium (Be), copper (Cu), zirconium (Zr), strontium (Sr), stannum (Sn) and barium (Ba).

25. The ceramic metal catalyst of claim 24, the wt % of the active catalytic material is between 0.01 and 80.

26. The ceramic metal catalyst of claim 24, wherein the clay is expressed as Formula 1 below
AlₓSi_{y}O_{z}Mₙ.(H₂O)ₘ, [Formula 1]
and wherein the wt % of each element/component is as follows:
Al=5˜58; Si=5˜54; O=20˜65; and H₂O=3˜35,
and wherein M is any metallic element except aluminium (Al) and silicon (Si).

27. The ceramic metal catalyst of claim 26, wherein the wt % of M is no more than 14.

28. A method for producing a ceramic metal catalyst, comprising the steps of:
mixing silica alumina having a sintered solid crystal structure and expressed as Formula 1 in claim 26 and the active catalytic material as in claim 24 in water to obtain a mixture;
removing water from the mixture and then forming this to a predetermined shaped material; and
sintering the shaped material at a temperature of 1,000° C. to 1,500° C. during a period of 2 hours to 24 hours.

29. A method for producing a ceramic metal catalyst, comprising the steps of:
mixing silica alumina having a sintered solid crystal structure and expressed as Formula 1 in claim 26 and the active catalytic material as in claim 24 in a powder form;
adding water to the mixture for plasticization and then forming this to a shaped material; and
sintering the shaped material at a temperature of 1,000° C. to 1,500° C. during a period of 2 hours to 24 hours.

30. A method for producing fatty acid alkyl ester, comprising the steps of:
placing the ceramic metal catalyst in accordance with claim 23 inside a reactor;
keeping the reaction temperature between 150° C. and 250° C. and the reaction pressure between 5 bar and 50 bar; and
performing transesterification with fatty acid and animal and/or vegetable oil with the equivalence ratio between the content of the fatty acid contained in the animal and/or vegetable oil and alcohol at 1:1 to 1:15.

31. The method of claim 30, wherein the oil includes at least one selected from soybean oil, rape seed oil, sunflower oil, palm oil, corn oil, cottonseed oil, castor oil, jatropha oil, coconut oil, palm seed oil, fish oil, beef tallow, pork lard and any waste cooking oil therefrom.

32. The method of claim 30, wherein the number of the carbon atom in the alcohol is between one and four, and the alcohol is at least one selected from methanol, ethanol, propanol, butanol and 2-ethyl hexanol.

33. The method of claim 30, wherein the placing step comprises a step of fixing the ceramic metal catalyst to the reactor.

34. A method for producing fatty acid alkyl ester, comprising the steps of:
placing the ceramic metal catalyst in accordance with claim 23 inside a reactor;
keeping the reaction temperature between 120° C. and 250° C. and the reaction pressure between 5 bar and 50 bar; and
performing transesterification with fatty acid with the equivalence ratio between the content of the fatty acid and alcohol at 1:1 to 1:15.

35. The method of claim 34, wherein the oil of the fatty acid includes at least one selected from soybean oil, rape seed oil, sunflower oil, palm oil, corn oil, cottonseed oil, castor oil, jatropha oil, coconut oil, palm seed oil, fish oil, beef tallow, pork lard and any waste cooking oil therefrom.

36. The method of claim 34, wherein the number of the carbon atom in the alcohol is between one and four, and the alcohol is at least one selected from methanol, ethanol, propanol, butanol and 2-ethyl hexanol.

37. The method of claim 34, wherein the placing step comprises a step of fixing the ceramic metal catalyst to the reactor.
